(19) United States
(12) Patent Application Publication
(10) Pub. No.: US 2012/0025694 A1
(43) Pub. Date: Feb. 2, 2012

(54) CHRISTMAS LAMP

(76) Inventor: ZHANG BING, Hubei Province (CN)

(21) Appl. No.: 13/110,906

(22) Filed: May 18, 2011

(30) Foreign Application Priority Data
Jul. 27, 2010 (CN) 201020275049.5

(51) Int. Cl. H01J 5/00

(52) U.S. Cl. 313/318.01

(57) ABSTRACT

A Christmas lamp comprises an LED lamps, a lamp stem connected with the LED lamp and a lamp holder in which the lamp stem is arranged, wherein the lamp holder is internally provided with a conductive element electrically connected with wires, the LED lamp is connected with the conductive element through the lamp stem, the conductive element comprises a first conductive element and a second conductive element which are positioned at the left side and the right side in the lamp holder, the lower part of the lamp stem is provided with a protruded end, the protruded end is clamped between the two conductive elements, the two lamp bases of the LED lamp are respectively contacted with and conductive with the two conductive elements, the inner wall of the lamp holder is provided with an elastic element which can enable the two conductive elements to be contacted with and conductive with current when the lamp stem is pulled out. The Christmas lamp of the utility model ensures the normal work of the Christmas lamps of whole string lamp, after the LED lamp has faults and is pulled out, under the action of the elastic element, the two conductive elements can be mutually contacted or contacted with the current through a sheet metal I and a sheet metal II to be conductive with the current, so that the normal work of other Christmas lamps of the string lamp can be ensured; at the same time, compared with the similar lamps, the structure of the Christmas lamp is easy to install and manufacture, and is suitable for the batch production, and the Christmas lamp with the structure is of small size, light weight, and can save the production cost.

### BACKGROUND OF THE INVENTION

The utility model relates to a lamp, in particular to a Christmas lamp.

At present, Christmas lamps in the market comprise an LED lamp, a lamp stem, a conductive element and wires; if the lamp has faults and can not normally work, or when the LED lamp falls from or is pulled out of the lamp holder, the whole serial string lamp connected with the lamp has an open circuit to put out so as to bring inconvenience to the users. Thereby, the manufacturer of the Christmas lamp developed an electronic and mechanical shunting device for solving the above defects, the electric shunting device is formed in a way that an electric element is arranged in the lamp holder to be connected with the LED lamp in parallel so as to realize the independent power supply of the lamp, the normal work of other lamps can not be influenced when one lamp has faults, but the electric element has a high cost, is inconvenient to manufacture, and increases the production cost of the enterprises; however, the mechanical shunting device has a relatively low price, and realizes current shunting by the way that conductive elements are arranged in the lamp holder to mutually contact; when the LED lamp is in the lamp holder, the lower part of the lamp stem separates the elastic elements not to be mutually contacted, at this time the LED lamp normally works, the current flows through the LED lamp to be conductive with other lamps of the string lamp; when the LED lamp has faults and is pulled out, the elastic conductive elements oppositely move under the action of their own elastic force to be mutually contacted and conductive for current shunting, the lamp with the structure realizes the current shunting function, but the manufacture is more difficult, the elastic conductive elements are not easy to install in the lamp holder, and during the manufacture and the transportation processes, the elastic conductive elements are easy to crush and deform so as to lose tension, so that the elastic conductive elements can not effectively rebound to be mutually contacted to be conductive with current when being installed in the lamp holder.

### BRIEF SUMMARY OF THE INVENTION

The utility model aims to overcome the defects in the prior art, and provides a Christmas lamp which is convenient to install, manufacture and has the shunting function so as to realize that the lamps connected at the front and back of the string lamp can be conductive with the current to normally work after one LED lamp has faults and is taken out.

In order to realize the above aim, the technical scheme of the utility model is that:

A Christmas lamp comprises an LED lamp, a lamp stem connected with the LED lamp and a lamp holder in which the lamp stem is arranged, wherein the lamp holder is internally provided with a conductive element electrically connected with wires, the LED lamp is connected with the conductive element through the lamp stem, the conductive element comprises a first conductive element and a second conductive element which are positioned at the left side and the right side in the lamp holder, the lower part of the lamp stem is provided with a protruded end, the protruded end is clamped between the two conductive elements, the two lamp bases of the LED lamp are respectively contacted with and conductive with the two conductive elements, and the inner wall of the lamp holder is provided with an elastic element which can enable the two conductive elements to be contacted to be conductive with the current.

The above one end of each conductive element is fixedly clamped in the lamp holder to respectively form fixed ends contacted with the lamp bases of the LED lamp, the other ends of the conductive elements are suspended movable ends connected with the wire, and the elastic element is positioned with the gaps among the inner wall of the lamp holder and the movable ends of the conductive elements.

The above movable ends of the two conductive elements are fully enclosed or semi-enclosed on wires, and the side walls of the movable ends of the two conductive elements, which are mutually closed, are electric contacts which can realize the electric conduction.

A sheet metal I which can enable the electric contacts of the movable ends of the two conductive elements to be conductive is arranged between the above movable ends of the two conductive elements.

A clamping slot is arranged in the above lamp holder, and the sheet metal I is directly arranged in the clamping slot to be fixed.

The above sheet metal I is linear, G-shaped or inverted U-shaped.

The above lamp holder is internally provided with a sheet metal II which can enable the electric contacts of the movable ends of the two conductive elements to be conductive, and the sheet metal II is respectively contacted with the front sides or the back sides of the first conductive element and the second conductive element.

Compared with the prior art, the advantageous effects of the utility model are as follows:

In the Christmas lamp of the utility model, the protruded end of the lamp stem separates the two conductive elements, at the same time, the two lamp bases of LED lamp are contacted with the two conductive elements, the current flows through the LED lamp to be conductive with other lamps of the string lamp, so that the LED lamps of the whole string lamp can normally work; when one LED lamp has faults and is pulled out, the elastic element drives the lower end of the first conductive element to shift and enables the two conductive elements to be mutually contacted to be conductive with the current, so that the other Christmas lamps in the string lamp can normally work; in addition, the sheet metal I is arranged between the lower parts of the first conductive element and the second conductive element or the sheet metal II is arranged with the front sides or the back sides of the first conductive element and the second conductive element, when one LED lamp has faults and is pulled out, under the action of the sheet metal I, the first conductive element and the second conductive element are contacted to be conductive with the current, or when one LED lamp has faults and is pulled out, the sheet metal II is conductive with the front sides or the back sides of the first conductive element and the second conductive element, so that the first conductive element and the second conductive element are mutually contacted to be conductive with the current, also, the normal work of other Christmas lamps of the string lamp can be ensured.

Compared with the similar lamps, the structure of the Christmas lamp is easy to install and manufacture, and is suitable for the batch production, and the Christmas lamp with the structure has a small size and light weight, and can save the production cost.

### BRIEF DESCRIPTION OF THE DRAWINGS

FIG. 1 is a breakdown structure schematic drawing of the embodiment 1 of the utility model;

FIG. 2 is an internal structure schematic drawing of the embodiment 1 of the utility model;

FIG. 3 is a front section view structural schematic drawing of the embodiment 1 of the utility model, in which, the LED lamp, the lamp stem and the elastic element are not installed in the lamp holder;

FIG. 4 is a front section view structural schematic drawing of the embodiment 1 of the utility model, in which, the LED lamp, the lamp stem and the elastic element are installed in the lamp holder;

FIG. 5 is the structural schematic drawing of the embodiment 1 of the utility model, in which, the LED lamp and the lamp stem are separated;

FIG. 6 is a structural schematic drawing of the embodiment 1 of the utility model, in which, a plurality of lamps are connected and normally work;

FIG. 7 is a structural schematic drawing of the embodiment 1 of the utility model, in which, a plurality of lamps are connected for the use when one lamp has faults;

FIG. 8 is a front section view structural schematic drawing of the embodiment 2 of the utility model, in which, the LED lamp, the lamp stem, the elastic element and the sheet metal I are installed in the lamp holder;

FIG. 9 is a front section view structural schematic drawing of the embodiment 2 of the utility model, in which, the LED lamp and the lamp stand are pulled out;

FIG. 10 is a three-dimension structural schematic drawing of the embodiment 2 of the utility model, in which, the LED lamp and the lamp stem are pulled out;

FIG. 11 is a front structural schematic drawing of the embodiment 3 of the utility model, in which, the LED lamp, the lamp stem, the elastic element and the sheet metal I are installed in the lamp holder;

FIG. 12 is a front structural schematic drawing of the embodiment 3 of the utility model, in which, the LED lamp and the lamp stem are pulled out;

FIG. 13 is a front structural schematic drawing of the embodiment 4 of the utility model, in which, the LED lamp, the lamp stem, the elastic element and the sheet metal I are installed in the lamp holder;

FIG. 14 is a front structural schematic drawing of the embodiment 4 of the utility model, in which, the LED lamp and the lamp stem are pulled out;

FIG. 15 is a front section view structural schematic drawing of the embodiment 5 of the utility model, in which, the LED lamp, the lamp stem, the elastic element and the sheet metal II are installed in the lamp holder;

FIG. 16 is a front structural schematic drawing of the embodiment 5 of the utility model, in which, the LED lamp and the lamp stem are separated from each other.

FIG. 17 is a three-dimension structural schematic drawing of the embodiment 5 of the utility model, in which, the LED lamp and the lamp stem are separated from each other.

### DETAILED DESCRIPTION OF THE INVENTION

In order to facilitate understanding of the skilled in the art, the further detail of the structural principle of the utility model, according to the specific embodiments and drawings, are as follows:

### Embodiment 1

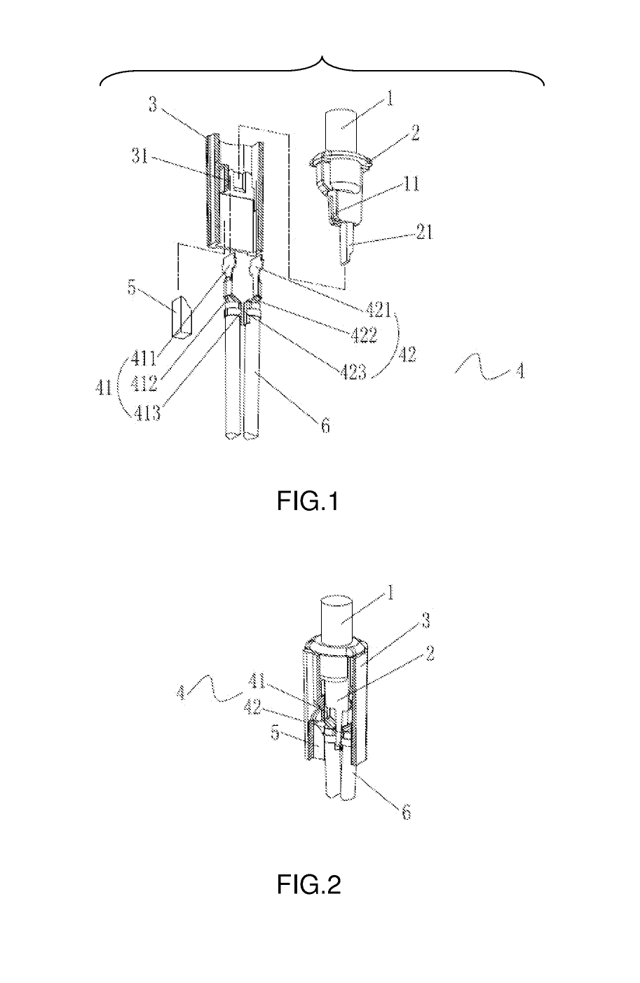

according to FIGS. 1˜7, the Christmas lamp disclosed by the scheme comprises an LED lamp 1, a lamp stem 2 connected with the LED lamp 1 and a lamp holder 3 at which the lamp stem 2 is arranged, wherein the lamp holder 3 is internally provided with a conductive element 4 electrically connected with wires 6, the LED lamp 1 is connected with the conductive element 4 through the lamp stem 2, and a plurality of Christmas lamps can be connected in series to form a string lamp.

Wherein the conductive element 4 comprises a first conductive element 41 and a second conductive 42 which are positioned at the left side and the right side in the lamp holder 3, the first conductive element 41 and the second conductive 42 are distributed in a splay entrance shape, one end of the two conductive element 4 is fixedly clamped in preset installation slot 31 in the lamp holder 3 to respectively form fixed ends 411 and 412 connected with the lamp bases 11 of the LED lamp,

The other ends of the two conductive elements 4 are suspended movable ends 412 and 422, the side walls of the movable ends 412 and 422 of the two conductive elements 4, which are mutually closed, are electric contacts 413 and 423 which can be contacted to realize the conduction, the movable ends 412 and 422 of the two conductive elements 4 are fully enclosed or semi-enclosed on wires 6, the first conductive element 41 is connected with the Christmas lamps positioned at the front part of the string lamp through the wires 6, the second conductive element 42 is connected with the Christmas lamps positioned at the back part of the string lamp through the wires 6, the two lamp bases 11 of the LED lamp 1 are respectively contacted with and conductive with the first conductive element 41 and the second conductive element 42, the lower part of the lamp stem 2 is provided with a protruded end 21, the protruded end 21 is clamped between the movable ends 412 and 422 of the two conductive elements 4, the protruded end 21 of the lamp stem 2 separates the movable ends 412 and 422 of the two conductive elements 4, the current is conductive to the LED lamp 1 through the first conductive element 41 from the wires 6 so as to maintain the normal work of the LED lamp 1, at the same time, the current flows from the second conductive element 42 to the wires 6 to be conductive to the next serial Christmas lamp, in this way, the Christmas lamps are connected from front to back, so that the normal work of the whole string lamp can be maintained.

In the embodiment, an elastic element 5 is arranged in the gaps among the inner wall of the lamp holder 3 and the movable ends 412 and 422 of the conductive element 4, the elastic element 5 can be an elastic rubber plug, when the LED lamp 1 normally works, the protruded end 21 of the lamp stem 2 separates the movable ends 412 and 422 of the conductive elements 4; at the same time, the elastic element 5 is compressed downwards to the inner wall of the lamp holder 3 under the downward crush action of the lamp stem 2; when the LED lamp 1 has faults and can not normally work, the LED lamp 1 and the lamp stem 2 are pulled out from the lamp holder 3, under the own elastic force, the elastic element 5 recovers to be in the state before being compressed; at the same time, the elastic element 5 drives the first conductive element 41 to move to the second conductive element 42 until the first conductive element 41 is contacted with the second conductive element 42 are mutually contacted to be conductive with the current, the current can not pass through the LED lamp 1 which has faults, but is directly conductive to the next lamp through the second conductive element 42 from the first conductive element 41.

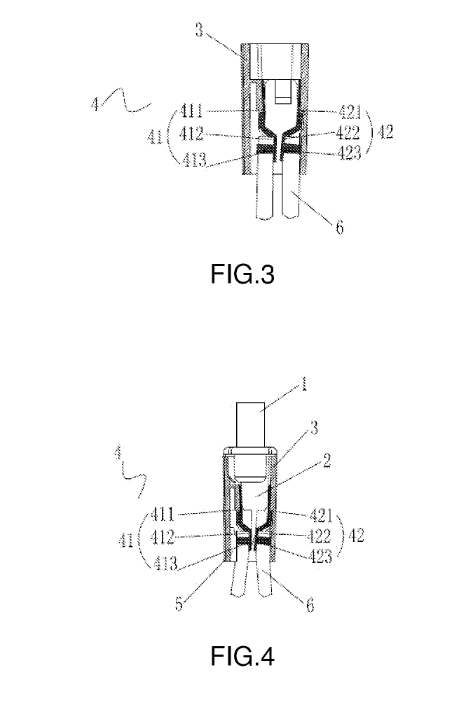

In the embodiment, according to FIG. 3, when the LED 1, the lamp stem 2 and the elastic element 5 are installed in the lamp holder 3, the fixed ends 411 and 412 of the two conductive elements 4 are fixed in the installation slot 31 of the lamp holder 3, a gap is left between the movable ends 412 and 422 of the conductive elements 4; according to FIG. 5, when the elastic element 5 is installed in the gap among the inner wall of the lamp holder 3 and the movable ends 412 and 422 of the conductive elements 4, the first conductive element 41 is open and moves to the second conductive element 42 until the first conductive element 41 is open and contacted with the second conductive element 42; according to the FIG. 4, the LED lamp 1 and the lamp stem move downwards to be installed in the lamp holder until the protruded end 21 of the lamp holder 2 separates the movable ends 412 and 422 of the two conductive elements 4, under the downward crush action of the lamp stem 2, the elastic element 5 is compressed downwards in the lamp holder 3, and the fixed ends 411 and 422 of the two conductive elements 4 are contacted with and conductive with the lamp bases 11 of the LED lamp1.

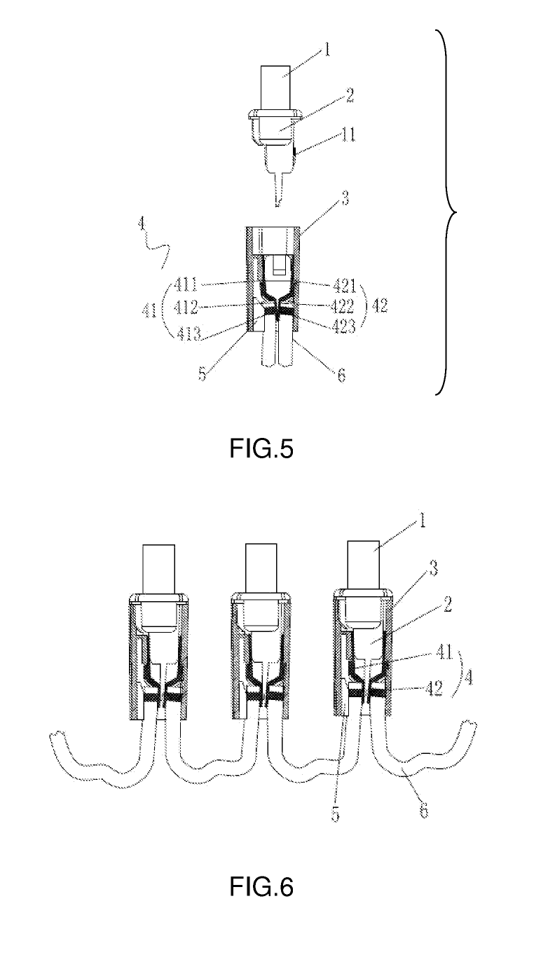

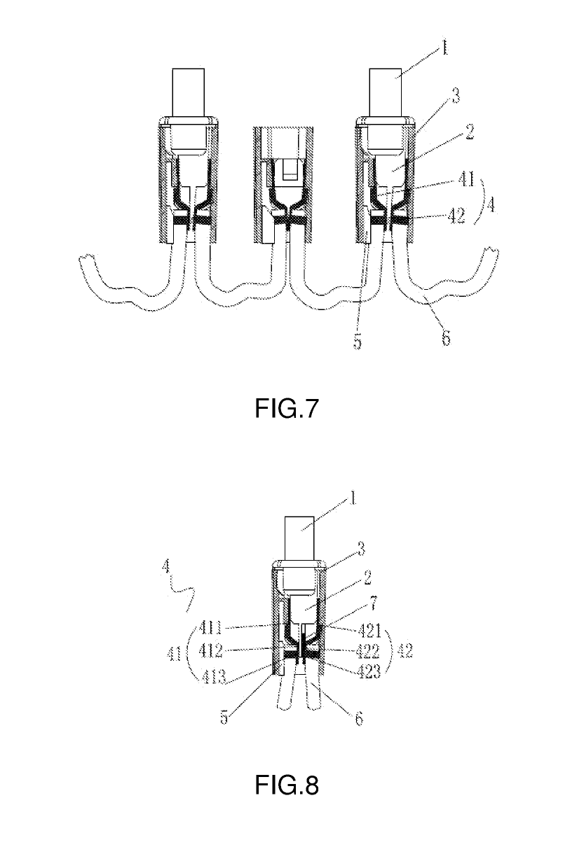

In the embodiment, the protruded end 21 of the lamp stem 2 separates the two movable ends 412 and 422 of the conductive elements 4; according to FIG. 6, a plurality of Christmas lamps are connected in series to form a string lamp, the current flows through the LED lamp 1 through the conductive element 4 to be conductive with other lamps of the string lamp, so that the normal work of the Christmas lamps of whole string lamp can be ensured. When one serial string lamp has faults, according to FIG. 7, the LED lamp 1 is pulled out, the elastic element 5 drives the first conductive element 41 to move to the second conductive element 42 until the first conductive element 41 and the second conductive element 42 are directly contacted to be conductive with the current, so that the other Christmas lamp of the string lamp can normally work and be used; at the same time, compared with the structures of other similar lamps, the structure of the Christmas lamp is easy to install and manufacture, and is suitable for the batch production, and the Christmas lamp with structure has small size and light weight, and can save production cost.

The LED lamp 1 of the Christmas lamp of the utility model can be replaced by common tungsten filament.

### Embodiment 2

according to FIGS. 8-10, the structure of the Christmas lamp disclosed by the embodiment is similar to the structure of the embodiment I, and the difference is that a sheet metal 17 is arranged between the movable ends 412 and 422 of the two conductive elements 4.

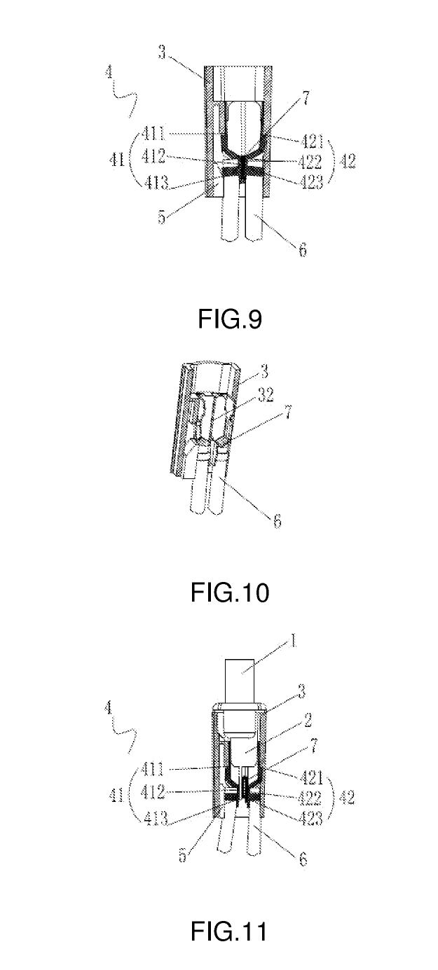

In the embodiment, a sheet metal 17 is arranged between the movable ends 412 and 422 of the first conductive element 41 and the second conductive element 42. The sheet metal 17 is linear, a clamping slot 32 is arranged in the lamp holder 3, the sheet metal 17 is directly inserted in the clamping slot 32 of the lamp holder 3 to be fixed, the sheet metal 17 is positioned in the lamp holder 3, one surface of the sheet metal 17 is contacted with the side of the protruded end 21 of the lamp stem 2, and the other surface of the sheet metal 17 is contacted with the electric contacts 413 and 423 of the conductive element 4. When the protruded end 21 of the lamp holder 2 is stretched into the movable ends 412 and 422 of the conductive element 4 to separate the linear sheet metal 17 and the conductive element 4; according to FIG. 8, a plurality of Christmas lamps are connected in series into a string lamp, the current flows through the LED lamp 1 through the conductive element 4 to be conductive with other lamps of the string lamp, so that the normal work of Christmas lamps of whole string lamp can be ensured; when one LED lamp 1 has faults and is pulled out, the elastic element 5 drives the movable end 412 of the first conductive element 41 to shift to the linear sheet metal 17, the linear sheet metal 17 shifts to the movable end 422 of the second conductive element 42, according to FIG. 9, so that the first conductive element 41 and the second conductive element 42 are contacted to be conductive with the current through the linear sheet metal 17, also, the normal work of other Christmas lamps of the string lamp can be ensured.

### Embodiment 3

according to FIGS. 11˜12, the structure of the Christmas lamp of the embodiment is similar to the structure in the embodiment 2, and the difference is that the sheet metal 17 is an inverted U-shape.

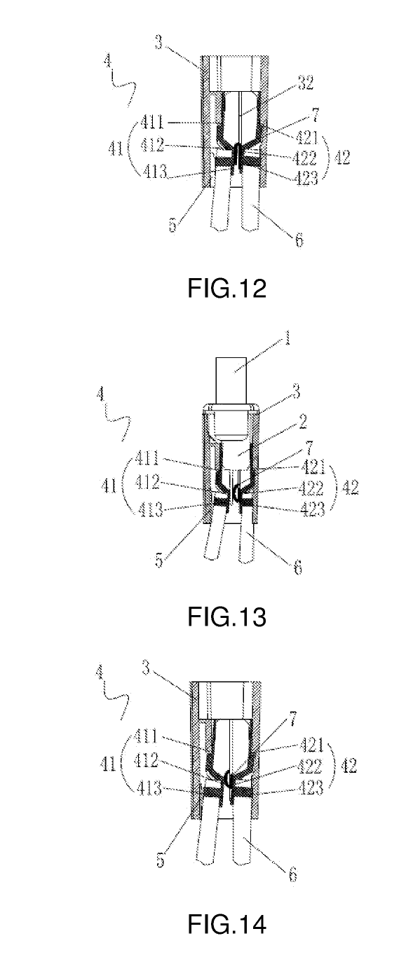

In the embodiment, the sheet metal 17 is an inverted U-shape, the inverted U-shaped sheet metal 17 is elastic, when the protruded end 21 of the lamp stem 2 of the Christmas lamp is stretched into the movable ends 412 and 422 of the conductive element 4 to separate the inverted U-shaped sheet metal 17 and the conductive element 4, according to FIG. 11, a plurality of Christmas lamps are connected in series to form a string lamp, the current flows through the LED lamp 1 through the conductive element 4 to be conductive with the other lamps of the string lamp, so that the normal work of the Christmas lamps of whole string lamp can be ensured; when one LED lamp 1 has faults and is pulled out, one end of the inverted U-shaped sheet metal 17 drives the conductive element 41 to shift to the elastic element 5, the inverted U-shaped sheet metal 17 is contacted with the first conductive element 41 so as to be conductive with the current, according to FIG. 12, also, the normal work of other Christmas lamps of the string lamp can be ensured.

### Embodiment 4

according to FIGS. 13-14, the structure of the Christmas lamp of the embodiment is similar to the structure in embodiment 3, and the difference is that the sheet metal 17 is G-shaped.

In the embodiment, the sheet metal 17 is G-shaped, the G-shaped sheet metal 17 is elastic, when the protruded end 21 of the lamp stem 2 of the Christmas lamp is stretched into the movable ends 412 and 422 of the conductive element 4 to separate the G-shaped sheet metal 17 and the conductive element 4, according to FIG. 13, a plurality of Christmas lamps are connected in series to form a string lamp, the current flows through the LED lamp 1 through the conductive element 4 to be conductive with the other lamps of the string lamp, so that the normal work of the Christmas lamps of whole string lamp can be ensured; when one LED lamp 1 has faults and is pulled out, one end of the G-shaped sheet metal 17 drives the conductive element 41 to shift to the elastic element 5, the G-shaped sheet metal 17 is contacted with the first conductive element 41 so as to be conductive with the current, according to FIG. 14, also, the normal work of other Christmas lamps of the string lamp can be ensured.

### Embodiment 5

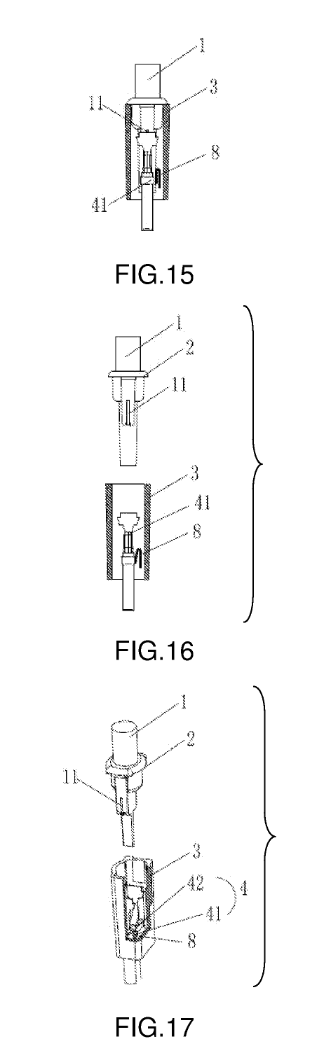

according to FIGS. 15˜17, the structure of the Christmas lamp of the embodiment is similar to the structure in the embodiment 1, and the difference is that the sheet metal II 8 is arranged at the front sides or the back sides of the first conductive element 41 and the second conductive element 42.

In the embodiment, the sheet metal II 8 is arranged at the front sides or the back sides of the first conductive element 41 and the second conductive element 42. The sheet metal II 8 is inverted U-shaped, and the inverted U-shaped sheet metal 17 is elastic, the sheet metal II 8 is respectively contacted with the sides or of the first conductive element 41 and the second conductive element 42. When the protruded end 21 of the lamp stem 2 of the Christmas lamp is stretched into the movable ends 412 and 422 of the conductive element 4 to separate the conductive element 4, at the same time, the sheet metal II 8 is separated from the sides or of the first conductive element 41 and the second conductive element 42, according to FIG. 13, a plurality of Christmas lamps are connected in series to form a string lamp, the current flows through the LED lamp 1 through the conductive element 4 to be conductive with the other lamps of the string lamp, so that the normal work of the Christmas lamp of whole string lamp can be ensured; when one LED lamp 1 has faults and is pulled out, the sheet metal II 8 is recovered to the original position, at the same time, the sheet metal II 8 is respectively contacted with the sides of the first conductive element 41 and the second conductive element 42 to be conductive with the current, according to FIG. 14, also, the normal work of other Christmas lamps of the string lamp can be ensured.

In addition, the sheet metal II 8 can be arranged at the sides and the back sides of the first conductive element 41 and the second conductive element 42 in the lamp holder 3.

The above embodiment is the preferable embodiment of the utility model, and in addition, the utility model has other embodiments. It is noted that any obvious alternative should fall in the protection scope of the utility model without departing from the intensive concept.

What is claimed is:

1. A Christmas lamp comprises an LED lamp (1), a lamp stem (2) connected with the LED lamp and a lamp holder (3) in which the lamp stem is arranged, wherein the lamp holder is internally provided with a conductive element (4) electrically connected with wires (6), the LED lamp is connected with the conductive element through the lamp stem, and the conductive element comprises a first conductive element (41) and a second conductive element (42) which are positioned at the left side and the right side in the lamp holder. The utility model is characterized in that the lower part of the lamp stem is provided with a protruded end (21), the protruded end is clamped between the two conductive elements, the two lamp bases (11) of the LED lamp are respectively contacted with and conductive with the two conductive elements, and the inner wall of the lamp holder is provided with an elastic element (5) which can enable the two conductive elements to be mutually contacted with and conductive with the current when the lamp is pulled out.

2. The Christmas lamp of claim 1, is characterized in that one end of each conductive element is fixedly clamped in the lamp holder to respectively from fixed ends (411, 421) which are contacted with the two lamp bases of the LED lamp, the other ends of the two conductive elements are suspended movable ends (412, 422) which are connected with the wires, and the elastic element is positioned in the gap among the inner wall of the lamp holder and the movable ends of the conductive ends.

3. The Christmas lamp of claim 2, is characterized in that the movable ends of the two conductive elements are fully enclosed or semi-enclosed on wires, and the side walls of the movable ends of the two conductive elements, which are mutually closed, are electric contacts (413, 423) which realize the contact and conduction.

4. The Christmas of claim 3, is characterized in that a sheet metal I (7) which can enable the electric contacts of the movable ends of the two conductive elements to conductive.

5. The Christmas lamp of claim 4, is characterized in that a clamping slot (32) is arranged in the lamp holder, and the sheet metal I is directly clamped in the clamping slot.

6. The Christmas lamp of claim 5, is characterized in that the cross section of the sheet metal I is linear, or G-shaped or inverted U-shaped.

7. The Christmas lamp of claim 3, is characterized in that the lamp holder is internally provided with a sheet metal II (8) which can enable the electric contacts of the movable ends of the conductive elements to be conductive, and the sheet metal II is respectively contacted with the front sides or the back sides of the first conductive element and the second element.
